(19) United States
(12) Patent Application Publication
(10) Pub. No.: US 2023/0247444 A1
(43) Pub. Date: Aug. 3, 2023

(54) POWER CONTROL FOR PHYSICAL RANDOM ACCESS CHANNEL TRANSMISSIONS

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 18/157,784

(22) Filed: Jan. 20, 2023

Related U.S. Application Data
(60) Provisional application No. 63/305,014, filed on Jan. 31, 2022.

(51) Int. Cl. H04W 16/28; H04W 74/08

(52) U.S. Cl. CPC H04W 16/28; H04W 74/0841; H04W 74/0891

(57) ABSTRACT

Apparatuses and methods for power control for physical random access channel transmissions. The method includes receiving a synchronization signal and physical broadcast channel (SS/PBCH) block based on a first spatial filter, determining a first power for a physical random access channel (PRACH) based on the SS/PBCH block, and transmitting first more than one PRACHs using respective first spatial filters. Each of the first spatial filters has a narrower beam-width than the first spatial filter. A power for each of the first more than one PRACH transmissions is the first power.

### CROSS-REFERENCE TO RELATED APPLICATION AND CLAIM OF PRIORITY

This application claims priority under 35 U.S.C. § 119(e) to U.S. Provisional Patent Application No. 63/305,014 filed on Jan. 31, 2022. The above-identified provisional patent application is hereby incorporated by reference in its entirety.

### TECHNICAL FIELD

The present disclosure relates generally to wireless communication systems and, more specifically, to power control for physical random access channel transmissions.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for power control for data and control channels.

In one embodiment, a user equipment (UE) is provided. The UE includes a transceiver configured to receive a synchronization signal and physical broadcast channel (SS/PBCH) block based on a first spatial filter. The UE further includes a processor operably coupled to the transceiver. The processor is configured to determine a first power for a physical random access channel (PRACH) based on the SS/PBCH block. The transceiver is further configured to transmit first more than one PRACHs using respective first more than one spatial filters. Each of the first more than one spatial filters has a narrower beam-width than the first spatial filter. A power for each of the first more than one PRACH transmissions is the first power.

In another embodiment, a base station (BS) is provided. The BS includes a transceiver configured to transmit a SS/PBCH block based on a first spatial filter and a processor operably coupled to the transceiver. The processor is configured to determine a first power for a PRACH based on the SS/PBCH block. The transceiver is further configured to receive first more than one PRACHs using respective first more than one spatial filters. Each of the first more than one spatial filters has a narrower beam-width than the first spatial filter. A power for each of the first more than one PRACH receptions is the first power.

In yet another embodiment, a method is provided. The method includes receiving a SS/PBCH block based on a first spatial filter, determining a first power for a PRACH based on the SS/PBCH block, and transmitting first more than one PRACHs using respective first more than one spatial filters. Each of the first more than one spatial filters has a narrower beam-width than the first spatial filter. A power for each of the first more than one PRACH transmissions is the first power.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIGS. 4 and 5 illustrate example wireless transmit and receive paths according to embodiments of the present disclosure;

FIG. 6 illustrates an example method of a UE configured for PRACH transmissions over multiple spatial settings according to embodiments of the present disclosure;

FIG. 7 illustrates an example method of a PRACH transmission with a spatial setting selected among a number of spatial settings used by the UE to determine corresponding RSRP values according to embodiments of the present disclosure;

FIG. 8 illustrates an example method of a UE receiving a channel state information reference signal (CSI-RS) configuration for determining a power for PRACH transmission according to embodiments of the present disclosure;

FIG. 9 illustrates an example method of a UE configuration for determining a power for PRACH transmission according to embodiments of the present disclosure;

FIG. 10 illustrates an example method of a UE transmitting multiple PRACH transmissions over multiple spatial settings with multiple transmission powers according to embodiments of the present disclosure;

FIG. 11 illustrates an example method for PRACH transmissions over multiple spatial settings with the same power according to embodiments of the present disclosure; and

FIG. 12 illustrates an example method for PRACH transmissions over multiple spatial settings with different powers according to embodiments of the present disclosure.

### DETAILED DESCRIPTION

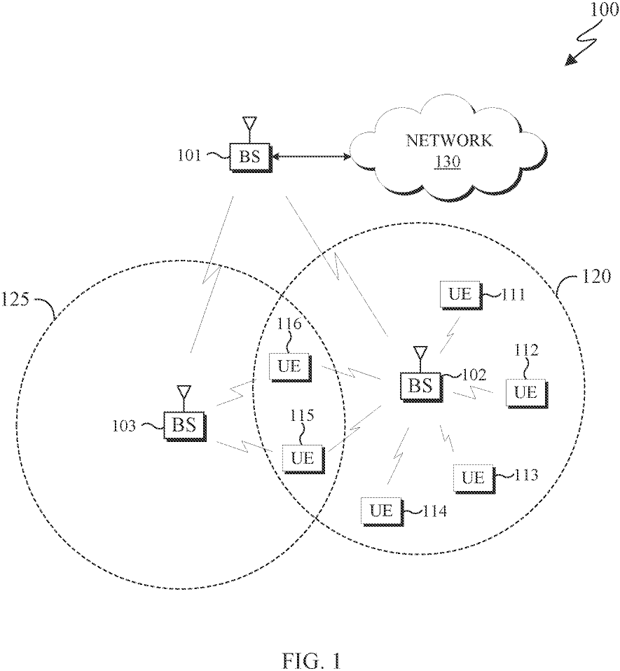

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 38.211 v17.3.0, “NR; Physical channels and modulation” (“REF1”); 3GPP TS 38.212 v17.3.0, “NR; Multiplexing and channel coding” (“REF2”); 3GPP TS 38.213 v17.3.0, “NR; Physical layer procedures for control” (“REF3”); 3GPP TS 38.214 v17.3.0, “NR; Physical layer procedures for data” (“REF4”); 3GPP TS 38.321 v17.2.0, “NR; Medium Access Control (MAC) protocol specification” (“REF5”); and 3GPP TS 38.331 v17.2.0, “NR; Radio Resource Control (RRC) protocol specification” (“REF6”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for power control for physical random access channel transmissions. In certain embodiments, one or more of the BSs 101-103 include circuitry, programing, or a combination thereof for power control for physical random access channel transmissions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

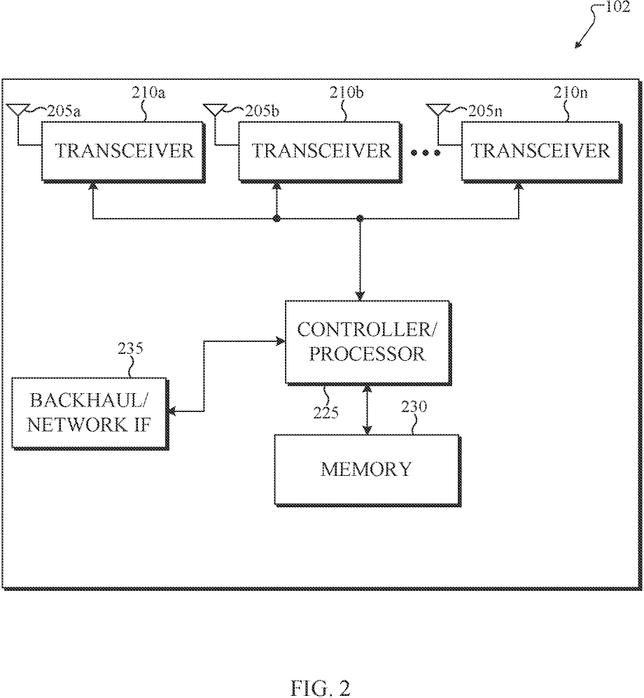

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n 3receive, from the antennas 205a-205n, incoming RF signals, such as signals transmitted by UEs in the network 100. The transceivers 210a-210n downconvert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for uplink transmission in full duplex systems. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

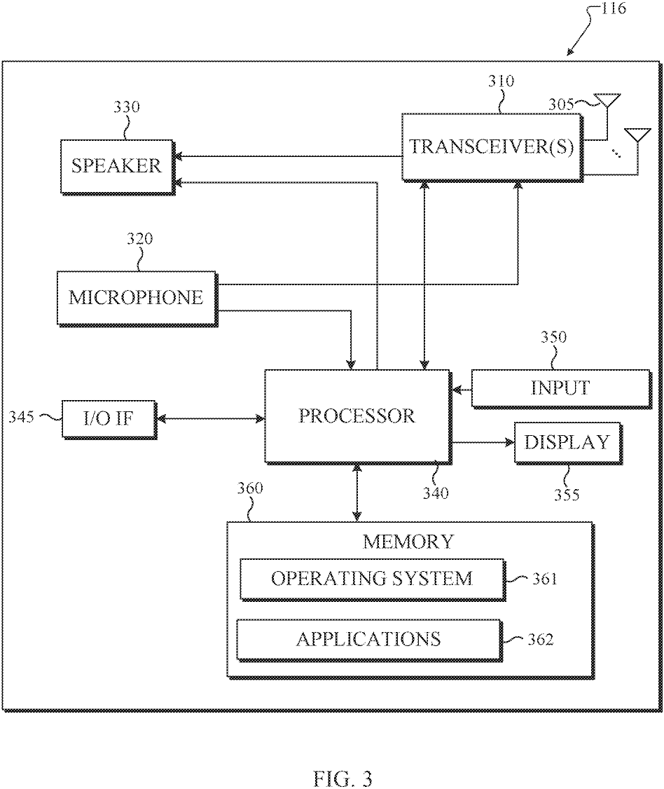

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

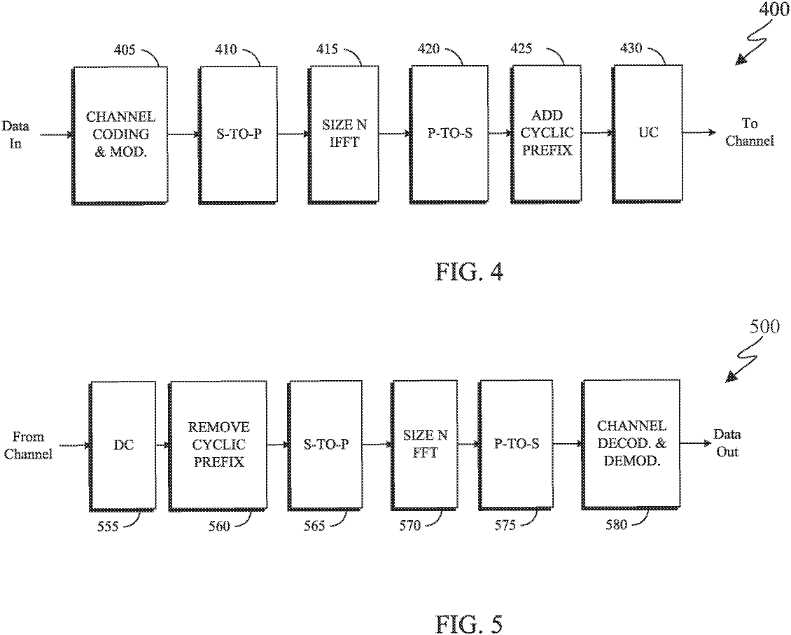

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116). However, it may be understood that the receive path 500 can be implemented in a BS and that the transmit path 400 can be implemented in a UE. In some embodiments, the receive path 500 is configured to support power control for physical random access channel transmissions as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

During initial cell search, a UE acquires/detects a synchronization signal/physical broadcast channel (SS/PBCH) block transmitted by a serving gNB. The gNB can transmit multiple SS/PBCH blocks with different quasi-collocation properties (beams). The UE typically acquires a SS/PBCH block corresponding to a largest signal to interference and noise ratio (SINR). In case of reciprocal reception/transmission quasi-collocation properties at the UE, the SS/PBCH block that the UE detects has quasi-collocation properties that best match the ones of transmissions from the UE. Then, the UE can transmit PRACH according to the spatial setting that is determined from the detected SS/PBCH block.

A UE can transmit a PRACH with a narrow beam and change a spatial setting of the PRACH transmission when the UE does not detect a RAR message addressing the UE in response to the PRACH transmission. The UE can also perform sweeping over multiple spatial settings for multiple PRACH transmissions before attempting to detect a RAR message. The gNB may be able to detect one or more of the UE transmissions, and based on the configuration of the PRACH transmission, the gNB can transmit one or more RARs to the UE. When the UE does not receive the RAR, either because the gNB has not detected the PRACH preamble from the UE, for example a corresponding spatial setting used by the UE does not provide sufficiently large SINR, or because although the gNB has successfully detected the PRACH preamble from the UE and has transmitted a RAR to the UE, the UE has not received the RAR, for example a corresponding spatial setting used by the gNB does not provide sufficiently large SINR, the UE may restart the RA procedure by transmitting one or more PRACH preambles using a same or different spatial setting or using multiple spatial settings. When a RAR is successfully received by the UE, the UE transmits a Msg3 PUSCH. When the Msg3 PUSCH is not correctly received by the gNB, the UE may have transmitted the Msg3 PUSCH using a spatial setting that does not provide sufficiently large SINR. The gNB can schedule a Msg3 retransmission from the UE, but the Msg3 retransmission from the UE would typically need to be with a spatial setting that provides sufficiently large SINR in order to be correctly received by the gNB.

A UE (such as the UE 116) can transmit PUSCH, PUCCH, SRS, or PRACH using different spatial settings and determine a power for a PUSCH, PUCCH, SRS or PRACH transmission. The determined power can be based on pathloss estimate(s) computed by the UE from receptions of reference signals, such as a SS/PBCH block or a CSI-RS, that are associated with a corresponding spatial setting and subject to a UE maximum transmission power in a transmission occasion.

Therefore, there is a need to determine a power for PRACH transmissions for a UE to transmit multiple PRACH transmissions using multiple spatial settings.

The present disclosure relates to a random access procedure for a UE to establish RRC connection with a serving gNB wherein the random access procedure includes a transmission of a PRACH from the UE, a RAR reception by the UE in response to the PRACH transmission and, for a contention based random access, a Msg3 PUSCH transmission from the UE for contention resolution. The disclosure relates to determining a power for a UE to transmit multiple PRACH transmissions using multiple spatial settings. The disclosure also relates to determining a power for PRACH transmissions over multiple spatial settings after the UE fails to receive a RAR after an initial PRACH transmission.

A UE can transmit different PRACH preambles or repeat a same PRACH preamble in a number of ROs using a same spatial setting or cycling over a number of different spatial settings. For example, a UE can transmit a same PRACH preamble or different PRACH preambles using a same spatial setting, and if the UE does not detect a RAR, the UE restarts the RA procedure using a different spatial setting. It is also possible that the UE transmits a same PRACH preamble or different PRACH preambles using different spatial settings before attempting to detect a RAR. Whether the UE uses a single or multiple spatial settings for multiple PRACH transmission can depend on a configuration by higher layers and can also depend on a UE capability. The configuration can indicate whether or not use multiple spatial settings, or can indicate the number of spatial settings or a maximum number of spatial settings that the UE can use for PRACH transmissions before attempting to detect a RAR. It is also possible that the UE is configured to transmit PRACH using multiple spatial settings if the UE is configured to transmit Msg3 PUSCH with multiple spatial settings. The Msg3 PUSCH transmission can be with one spatial setting from the multiple spatial settings.

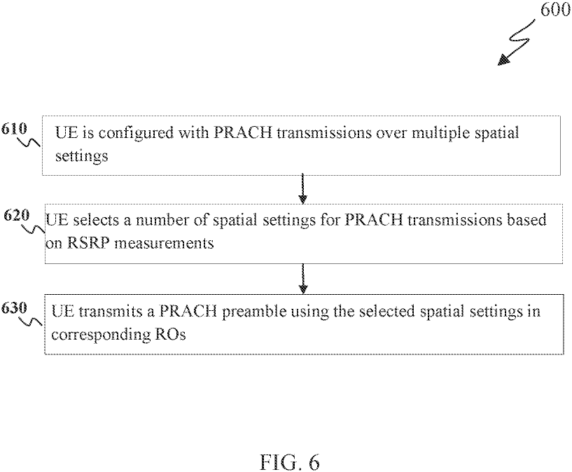

FIG. 6 illustrates an example method 600 of a UE configured for PRACH transmissions over multiple spatial settings according to embodiments of the present disclosure. The embodiment of the method 600 of a UE configured for PRACH transmissions over multiple spatial settings illustrated in FIG. 6 is for illustration only. FIG. 6 does not limit the scope of this disclosure to any particular implementation of the method of a UE configured for PRACH transmissions over multiple spatial settings.

As illustrated in FIG. 6, at step 610, a UE (such as the UE 116) is configured with PRACH transmissions over multiple spatial settings. At step 620, the UE selects a number of spatial settings for PRACH transmissions based on RSRP measurements. At step 730, the UE transmits a PRACH preamble using the selected spatial settings in corresponding ROs.

When a UE transmits one or more PRACH preambles over multiple spatial settings, the UE can transmit with a same power on all spatial settings or with different power on different spatial settings.

Various embodiments provide for determination of multiple transmission powers for PRACH transmissions with different spatial settings. The following description of the determination of a PRACH transmission power for transmission with spatial setting p refers to a UE transmitting in an active UL BWP b of carrier ƒ and spatial setting p of serving cell c.

A UE determines a transmission power for a PRACH, P_{PRACH,b,f,c}(i), on active UL BWP b of carrier ƒ of serving cell C based on DL RS for serving cell Cin transmission occasion i as P_{PRACH,b,f,c,p}(i) = min{P_{CMAX,f,c}(i), P_{PRACHtarget,f,c} + PL_{b,f,c,p}} [dBm], where P_{CMAX,f,c}(i) is a UE configured maximum output power for carrier ƒ of serving cell C within transmission occasion i, P_{PRACHtarget,f,c} is the PRACH target reception power PREAMBLE_RECEIVED_TARGET_POWER provided by higher layers for the active UL BWP b of carrier ƒ of serving cell C, and PL_{b,f,c,p} is a pathloss for the active UL BWP b of carrier ƒ based on the DL RS associated with the PRACH transmission on the active DL BWP of serving cell C and calculated by the UE as PL_{b,f,c,p} = [referenceSignalPower - higher layer filtered RSRP], wherein the referenceSignalPower is provided by higher layers, and the higher layer filtered RSRP is defined in TS 38.215 for the reference serving cell and the higher layer filter configuration provided by QuantityConfig for the reference serving cell in TS 38.331, and is per spatial setting. If the active DL BWP is the initial DL BWP and for SS/PBCH block and CORESET multiplexing pattern 2 or 3, the UE determines PL_{b,f,c,p} based on the SS/PBCH block associated with the PRACH transmission. The referenceSignalPower is provided by ss-PBCH-BlockPower which is an average energy per resource element (EPRE) of the resource elements that carry secondary synchronization signals used for SSB transmission.

The UE can estimate multiple pathloss values associated with the reception of SS/PBCH blocks. The UE can select the SS/PBCH block corresponding to the smallest pathloss and transmit a PRACH using a transmit spatial setting same as the receive spatial setting used for the reception of the selected SS/PBCH block and with a transmission power determined using the smallest pathloss. The UE can also transmit multiple PRACHs with the same spatial setting and with the same transmission power.

The UE can also estimate multiple pathloss values associated with the reception of one SS/PBCH block by using multiple receive spatial settings and determine spatial settings corresponding to the smallest pathloss values for the transmission of multiple PRACHs with transmission powers determined based on the smallest pathloss values. The UE can first select the SS/PBCH block associated with the smallest pathloss when using a first spatial setting for reception, and then estimate the pathloss values associated with the reception of the selected SS/PBCH block using multiple spatial settings that are narrower than the first spatial setting and may be included in the wider first spatial setting. Then the UE can use some or all of the narrower spatial settings for multiple PRACH transmissions. The UE can transmit the multiple PRACHs with different spatial settings with a same power or with different powers. When using the same power for the multiple PRACH transmissions, the power can be determined based on the pathloss associated with the reception of the SS/PBCH with the wider spatial setting or by averaging the pathloss values associated with the receptions of the SS/PBCH block using the narrower spatial settings. When using multiple powers for the multiple PRACH transmissions, the powers can be determined based on the pathloss values associated with the receptions of the SS/PBCH block using the narrower spatial settings.

When a UE is provided a CSI-RS resource configuration, the UE can estimate pathloss values associated with the reception of CSI-RS resources. The UE can select the CSI-RS resource corresponding to the smallest pathloss and transmit a PRACH using a transmit spatial setting that is the same as the receive spatial setting used for the reception of the selected CSI-RS resource and a transmission power determined using the smallest pathloss. The UE can also transmit multiple PRACHs with the same spatial setting and with the same transmission power.

The UE can also estimate multiple pathloss values associated with the reception of one CSI-RS resource by using multiple receive spatial settings and determine spatial settings corresponding to the smallest pathloss values for the transmission of multiple PRACHs with transmission powers determined based on the smallest pathloss values. The UE can first select the CSI-RS resource associated with the smallest pathloss when using a first spatial setting for reception, and then estimate the pathloss values associated with the reception of the selected CSI-RS resource using multiple spatial settings that are narrower than the first spatial setting and may be included in the wider first spatial setting. Then the UE can use some or all of the narrower spatial settings for multiple PRACH transmissions. The UE can transmit the multiple PRACHs with different spatial settings with a same power or with different powers. When using the same power for the multiple PRACH transmissions, the power can be determined based on the pathloss associated with the reception of the CSI-RS resource with the wider spatial setting or on the average of the pathloss values associated with the receptions of the CSI-RS resource using the narrower spatial settings. When using multiple powers for the multiple PRACH transmissions, the powers can be determined based on the pathloss values associated with the receptions of the CSI-RS resource using the narrower spatial settings. Alternatively or additionally, the UE can be indicated CSI-RS resource configuration indexes associated with the active TCI states for PDCCH receptions, and the UE can estimate pathloss values associated with the receptions of the indicated CSI-RS resources in the indicated TCI states to determine one or multiple spatial settings, and corresponding one or multiple transmission powers, for the one or multiple PRACH transmissions based on the TCI states associated with the smallest pathloss values. It is also possible that the UE transmits multiple PRACHs with multiple spatial settings associated to one indicated CSI-RS resource and/or to one indicated TCI state, and with same power associated to one indicated CSI-RS resource and/or to one indicated TCI state.

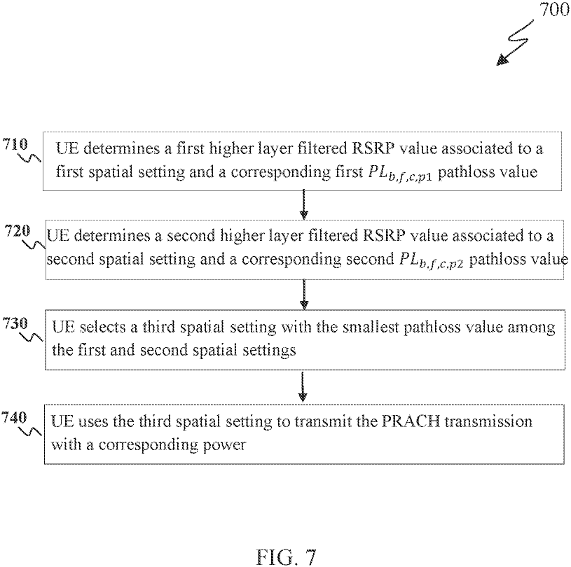

FIG. 7 illustrates an example method 700 of a PRACH transmission with a spatial setting selected among a number of spatial settings used by the UE to determine corresponding RSRP values, wherein the RSRP values and corresponding pathloss values are associated with the reception of a single SS/PBCH block or with receptions of multiple SS/PBCH blocks, according to embodiments of the disclosure. The embodiment of the method 700 of a PRACH transmission with a spatial setting selected among a number of spatial settings used by the UE to determine corresponding RSRP values, wherein the RSRP values and corresponding pathloss values are associated with the reception of a single SS/PBCH block or with receptions of multiple SS/PBCH blocks illustrated in FIG. 7 is for illustration only. FIG. 7 does not limit the scope of this disclosure to any particular implementation of the method of a PRACH transmission with a spatial setting selected among a number of spatial settings used by the UE to determine corresponding RSRP values, wherein the RSRP values and corresponding pathloss values are associated with the reception of a single SS/PBCH block or with receptions of multiple SS/PBCH blocks.

As illustrated in FIG. 7, at step 710, a UE (such as the UE 116) determines a first higher layer filtered RSRP value associated to a first spatial setting and a corresponding first PL_{b,f,c,p1} pathloss value. At step 720, the UE determines a second higher layer filtered RSRP value associated to a second spatial setting and a corresponding second PL_{b,f,c,p2} pathloss value. At step 730, the UE selects a third spatial setting with the smallest pathloss value among the first and second spatial settings. At step 740, the UE uses the third spatial setting to transmit the PRACH transmission.

It is possible that the UE receives information in a SIB or in a dedicated higher layer parameter for a set of CSI-RS configurations and determines the pathloss based on CSI-RS resources. When the UE uses the CSI-RS resources to determine the pathloss, the referenceSignalPower is obtained by ss-PBCH-BlockPower and powerControlOffsetSS where powerControlOffsetSS provides an offset of CSI-RS transmission power relative to SS/PBCH block transmission power. IfpowerControlOffsetSS is not provided to the UE, the UE assumes an offset of 0 dB. Thus, if a PRACH transmission from a UE is not in response to a detection of a PDCCH order by the UE, or is in response to a detection of a PDCCH order by the UE that triggers a contention based random access procedure, referenceSignalPower is provided by ss-PBCH-BlockPower and powerControlOffsetSS, if provided.

When a UE receives information in a SIB or in a dedicated higher layer parameter for a set of CSI-RS configurations, the UE can use either the CSI-RS resources to determine the pathloss for PRACH transmission or the SS/PBCH blocks. It is possible that the UE receives information in the SIB or in a dedicated higher layer parameter whether to use the CSI-RS resources or SS/PBCH blocks to determine the pathloss for the PRACH transmission when the PRACH transmission is not in response to a detection of a PDCCH order by the UE or is in response to a detection of a PDCCH order by the UE that triggers a contention based random access procedure. It is also possible that the UE receives information in the SIB or in a dedicated higher layer parameter on whether to use the CSI-RS resources or SS/PBCH blocks to determine the pathloss for the PRACH transmission independently of a PRACH transmission being triggered by a PDCCH order or, if triggered by a PDCCH order, if the triggered random access procedure is contention free or contention based random access procedure.

If a PRACH transmission from a UE is in response to a detection of a PDCCH order by the UE that triggers a contention-free random access procedure and depending on the DL RS that the DM-RS of the PDCCH order is quasi-collocated with, referenceSignalPower is provided by ss-PBCH-BlockPower or, if the UE is configured resources for a periodic CSI-RS reception or the PRACH transmission is associated with a link recovery procedure where a corresponding index q_{new} is associated with a periodic CSI-RS configuration, referenceSignalPower is obtained by ss-PBCH-BlockPower and powerControlOffsetSS, if provided. A same value of powerControlOffsetSS is configured for the UE to use independently of whether the PRACH transmission from the UE is in response to a detection of a PDCCH order or not.

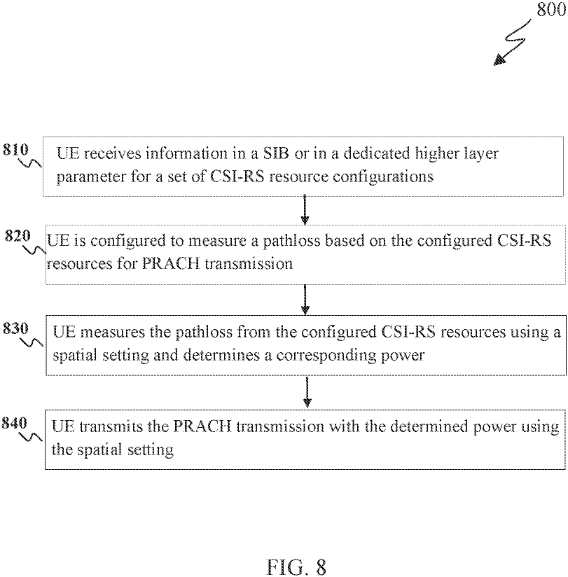

FIG. 8 illustrates an example method 800 of a UE receiving a CSI-RS configuration for determining a power for PRACH transmission according to embodiments of the present disclosure. The embodiment of the method 800 of a UE receiving a CSI-RS configuration for determining a power for PRACH transmission illustrated in FIG. 8 is for illustration only. FIG. 8 does not limit the scope of this disclosure to any particular implementation of the method of a UE receiving a CSI-RS configuration for determining a power for PRACH transmission.

As illustrated in FIG. 8, at step 810, a UE (such as the UE 116) receives information in a SIB or in a dedicated higher layer parameter for a set of CSI-RS resource configurations. At step 820, the UE is configured to measure a pathloss based on the configured CSI-RS resources for PRACH transmission. At step 830, the UE measures the pathloss from the configured CSI-RS resources using a spatial setting and determines a corresponding power. At step 840, the UE transmits the PRACH transmission with the determined power using the spatial setting. Additionally, at step 830 the UE can be configured with an offset of CSI-RS transmission power relative to SS/PBCH block transmission power, wherein the offset is used to calculate the pathloss that is used to calculate the PRACH power. Alternatively or additionally, at step 840 the UE transmits multiple PRACHs with the determined power using the spatial setting.

It is also possible that when the UE is provided information in a SIB or in a dedicated higher layer parameter for a set of CSI-RS resource configurations, the UE is also provided a reference signal power associated to the CSI-RS resources. For example, referenceSignalPower is provided by a higher layer parameter CSI-RSPower which is an average EPRE of the CSI-RS resource elements used for CSI-RS transmission.

A UE can be configured to use CSI-RS resources for the calculation of a pathloss to determine a transmission power of a PRACH transmission and/or for the calculation of the pathloss to determine spatial settings for the PRACH transmission.

When a UE transmits multiple PRACH transmissions over multiple spatial settings, the UE can use a same power for the multiple transmissions. The UE can estimate the pathloss for a number of spatial settings and determine the power of the PRACH transmissions based on a largest pathloss or based on an average pathloss value among the pathloss values corresponding to the number of spatial settings. The UE can be configured with using same or different power for PRACH transmissions over multiple spatial settings. The UE can be also configured with using same power for PRACH transmissions over multiple spatial settings, wherein the power is determined using the largest pathloss among the pathloss estimates for the different spatial settings. This can be useful to enhance coverage and can be an information received by the UE in a SIB or in a dedicated higher layer parameter. It is possible that the UE is configured with multiple PRACH transmissions and the UE can transmit the multiple PRACH transmissions with the same or different power.

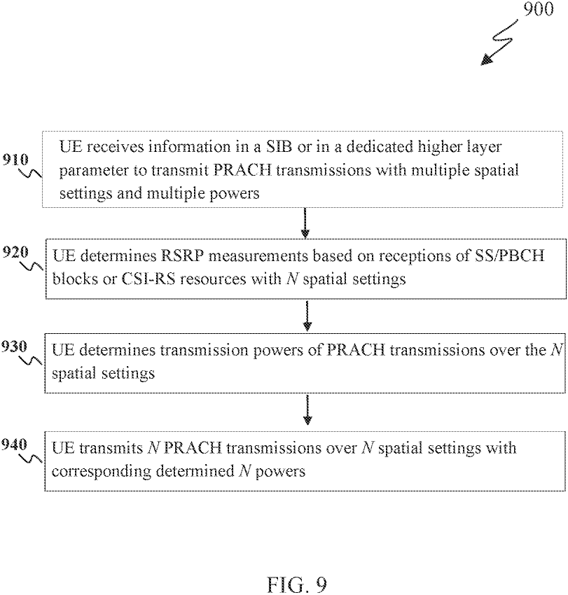

FIG. 9 illustrates an example method 900 of a UE configuration for determining a power for PRACH transmission according to embodiments of the present disclosure. The embodiment of the method 900 of a UE configuration for determining a power for PRACH transmission illustrated in FIG. 9 is for illustration only. FIG. 9 does not limit the scope of this disclosure to any particular implementation of the method of a UE configuration for determining a power for PRACH transmission.

As illustrated in FIG. 9, at step 910, a UE (such as the UE 116) receives information in a SIB or in a dedicated higher layer parameter to transmit PRACH transmissions with multiple spatial settings and multiple powers. At step 920, the UE determines RSRP measurements based on receptions of SS/PBCH blocks or CSI-RS resources with N spatial settings. At step 930, the UE determines transmission powers of PRACH transmissions over the N spatial settings. At step 940, the UE transmits N PRACH transmissions over N spatial settings with corresponding determined N powers.

A gNB can partition PRACH resources and reserve a set of PRACH resources for UEs in poor coverage. The set of PRACH resources can be reserved for coverage enhancement (CE) UEs, wherein CE UEs can be UEs that request to transmit Msg3 PUSCH with repetitions and/or request to be configured with DM-RS bundling for PUSCH and/or PUCCH transmissions and/or request to be configured with counting of available slots and/or UEs that transmit multiple PRACH transmission with same or different spatial settings and/or UEs that transmit a PUCCH with HARQ-ACK with repetitions when there are no dedicated PUCCH resources assigned to the UE. A UE that selects a PRACH resource from the set of PRACH resources reserved for CE UEs would use multiple spatial settings for multiple PRACH transmissions and use different powers for PRACH transmissions over different spatial settings. It is possible that the UE that selects a PRACH resource from the set of PRACH resources reserved for CE UEs would use multiple spatial settings for multiple PRACH transmissions and use a same power for PRACH transmissions over different spatial settings, wherein the power is determined based on a largest pathloss or based on an average pathloss value among the pathloss values corresponding to the number of spatial settings. It is also possible that the multiple PRACH transmissions are with a same spatial setting.

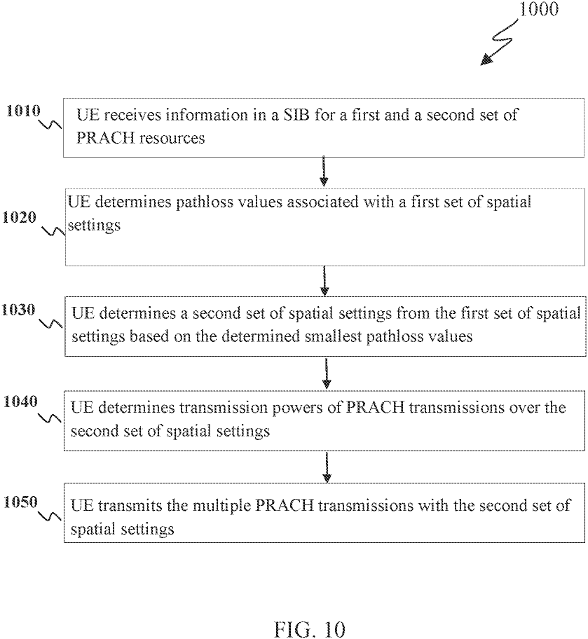

FIG. 10 illustrates an example method 1000 of a UE transmitting multiple PRACH transmissions with multiple spatial settings with multiple transmission powers according to embodiments of the present disclosure. The embodiment of the method 1000 of a UE transmitting multiple PRACH transmissions over multiple spatial settings with multiple transmission powers illustrated in FIG. 10 is for illustration only. FIG. 10 does not limit the scope of this disclosure to any particular implementation of the method of a UE transmitting multiple PRACH transmissions over multiple spatial settings with multiple transmission powers.

As illustrated in FIG. 10, at step 1010, a UE (such as the UE 116) receives information in a SIB for a first and a second set of PRACH resources, wherein the first set of PRACH resources is associated with multiple PRACH transmissions [with multiple spatial settings] and the second set is associated with single PRACH transmission. At step 1020, the UE determines pathloss values associated with a first set of spatial settings. At step 1030, the UE determines a second set of spatial settings from the first set of spatial settings based on the determined smallest pathloss values. At step 1040, the UE determines transmission powers of PRACH transmissions for the second set of spatial settings. At step 1050, the UE transmits the multiple PRACH transmissions with the second set of spatial settings. Alternatively or additionally, at step 1010 the first set of PRACH resources is associated with CE UEs that request to transmit Msg3 PUSCH with repetitions. It is also possible that the first set of PRACH resources is associated with PUSCH and/or PUCCH and/or SRS transmissions using multiple spatial settings.

Various embodiments provide for determination of a transmission power for PRACH retransmissions by cycling over different spatial settings. A UE can either transmit a PRACH preamble with a spatial setting, wherein the spatial setting can be determined from measurements of SS/PBCH block receptions and/or receptions in CSI-RS resources, if configured, or transmit a PRACH preamble by cycling over different spatial settings. The UE can determine a power for a PRACH transmission based on whether or not PRACH preambles are transmitted by cycling over different spatial settings. For example, when the UE transmits a number of PRACH preambles by cycling over different spatial settings before a RAR reception for the number of PRACH preambles, all transmissions can be with same power, while when the UE transmits PRACH preambles after corresponding RAR receptions (with incorrect decoding), the UE applies power ramping for transmission of PRACH preambles associated with different RAR receptions. In another example, when the UE transmits a number of PRACH preambles by cycling over different spatial settings before a RAR reception for the number of PRACH preambles, the PRACH preambles are transmitted with powers determined from pathloss estimates over the different spatial settings, while when the UE transmits PRACH preambles after corresponding RAR receptions (with incorrect decoding), the UE applies power ramping for transmission of PRACH preambles associated with different RAR receptions.

When a UE transmits multiple PRACH transmissions with multiple spatial settings that are associated with a single or multiple SS/PBCH block(s) and/or with a single or multiple CSI-RS resource(s), if configured, and does not receive a RAR, the UE performs a PRACH retransmission using same or different spatial settings.

In a first example, a UE uses a same set of spatial settings for an initial transmission of multiple PRACHs and a retransmission of multiple PRACHs, and the transmission powers for the retransmissions are determined according to a preamble power ramping procedure that includes a counter. The power ramping counter is incremented for each retransmission by a power ramping step that indicates the amount of power increase. Thus, the power of the each PRACH retransmission using the same spatial setting is increased by the power ramping step, for example 3 dBm or 4 dBm, until the UE reaches the maximum power, or the maximum number of retransmissions is reached. The preamble power ramping procedure can include a single counter for the multiple spatial settings or can include separate counters for each of the multiple spatial settings. If the multiple spatial settings are associated with a single pathloss value PL of a SS/PBCH block or of a CSI-RS resource, the preamble power ramping procedure includes a single power ramping counter. For a retransmission, a transmission power of each of the PRACHs with different spatial settings is the same and is increased by the power ramping step. If the multiple spatial settings are associated with multiple pathloss values PLᵢ, i=1, 2, ..., N, that are estimated using a single or multiple SS/PBCH block(s) or CSI-RS resource(s), the preamble power ramping procedure includes multiple power ramping counters, wherein each counter is associated with a pathloss value, or equivalently is associated with a spatial setting when the mapping of spatial settings and pathloss values is a 1-to-1 mapping. For a retransmission, a transmission power of a first PRACH with a first spatial setting is increased by a first step of a first counter associated with the first spatial setting that is associated with a first pathloss value, a transmission power of a second PRACH with a second spatial setting is increased by a second step of a second counter associated with the second spatial setting that is associated with a second pathloss value, and so on.

In a second example, a UE uses a first set of spatial settings for an initial transmission of multiple PRACHs and a second set of spatial settings for a retransmission of multiple PRACHs, wherein the first and second sets may or may not include a same spatial setting. For a PRACH retransmission using the same spatial setting used in the initial transmission, the transmission power is increased according to the step of the counter corresponding to the spatial setting. For a PRACH retransmission using a different spatial setting than the spatial settings used in the initial transmission, the transmission power is not increased according to the power ramping procedure and is calculated based on the pathloss associated with the spatial setting used for the retransmission. This is the same procedure used for determining the transmission power of any initial PRACH transmission. The power ramping counter for the spatial setting that is no longer used is suspended, and Layer 1 notifies higher layers to suspend the power ramping counter.

In a third example, when a UE is configured with multiple PRACH transmissions, if all spatial settings used for the initial transmissions are the same spatial settings used for the retransmissions, the powers of the retransmissions are determined according to the corresponding power ramping counter, otherwise the UE determines the powers for the retransmissions from the pathloss estimates following the same procedure as for the determination of the powers for the initial transmissions.

In a fourth example, when a UE is configured with multiple PRACH transmissions, the powers of the retransmissions are determined using the same procedure used for determining the powers of the initial transmissions, without using a power ramping counter for the retransmissions. Thus, when the UE is configured with multiple PRACH transmissions, prior to PRACH retransmissions, Layer 1 notifies higher layers to suspend the power ramping counter.

In a fifth example, when a UE is configured with multiple PRACH transmissions, the UE can transmit the multiple PRACH transmissions with a same spatial setting and determine the power of the multiple PRACH transmissions using a pathloss that is based on an SS/PBCH block reception. For PRACH retransmissions, the UE can transmit the multiple PRACHs using multiple spatial settings that are narrower than the spatial setting used for the initial transmission, wherein the spatial setting of the initial transmission includes the narrow spatial settings used for the retransmissions. The powers for the retransmissions can be determined by the pathloss values associated with the narrow spatial settings, or can be determined by applying a power ramping procedure based on the power of the initial transmissions, and all retransmissions can be transmitted with the same power, or can be the same as the power for the initial transmission.

In a sixth example, when a UE is configured with multiple PRACH transmissions, the UE can transmit the multiple PRACH transmissions with different spatial settings and determine the powers of the multiple PRACH transmissions using pathloss values based on an SS/PBCH block reception with the different spatial settings. For PRACH retransmissions, the UE can transmit the multiple PRACHs using a same spatial setting. For example, the UE can select the spatial setting associated with the smallest pathloss among the spatial settings used in the initial transmission, for use in the retransmissions. The powers for the retransmissions can be the same and determined based on the power of the initial transmissions.

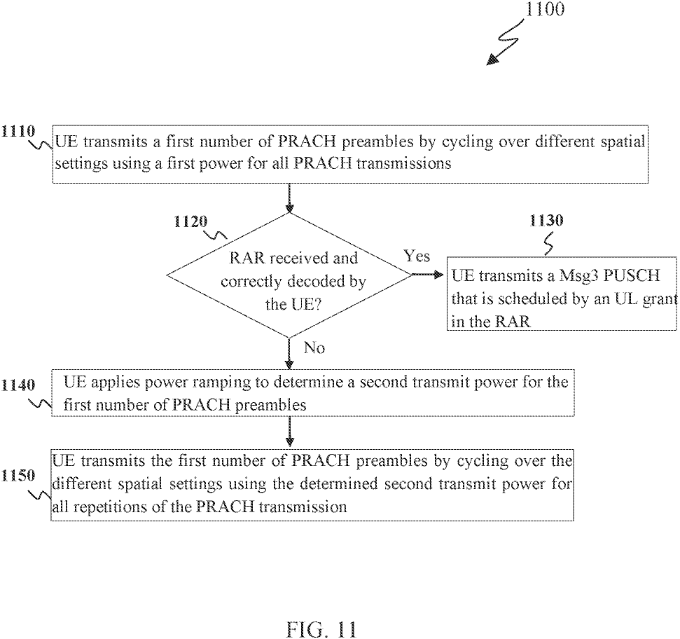

FIG. 11 illustrates an example method 1100 for PRACH transmissions over multiple spatial settings with the same power according to embodiments of the present disclosure. The embodiment of the method 1100 for PRACH transmissions over multiple spatial settings with the same power illustrated in FIG. 11 is for illustration only. FIG. 11 does not limit the scope of this disclosure to any particular implementation of the method for PRACH transmissions over multiple spatial settings with the same power.

As illustrated in FIG. 11, at step 1110, a UE (such as the UE 116) transmits a first number of PRACH preambles by cycling over different spatial settings using a first power for all PRACH transmissions. A second number of one or more PRACH preambles can be transmitted with each spatial setting from the different spatial settings, wherein the second number can be indicated in a SIB or determined by the UE, for example as a ratio of a total number of repetitions for a PRACH preamble transmission and a number of spatial settings to be used for the PRACH preamble transmission. At step 1120, when the UE receives and correctly decodes a RAR, then at step 1130 the UE transmits a Msg3 PUSCH that is scheduled by an UL grant in the RAR. Otherwise, at step 1140, the UE applies power ramping to determine a second transmit power for the first number of PRACH preamble. At step 1150, the UE then transmits the first number of PRACH preambles by cycling over the different spatial settings using the determined second transmit power for all repetitions of the PRACH transmission over the different spatial settings.

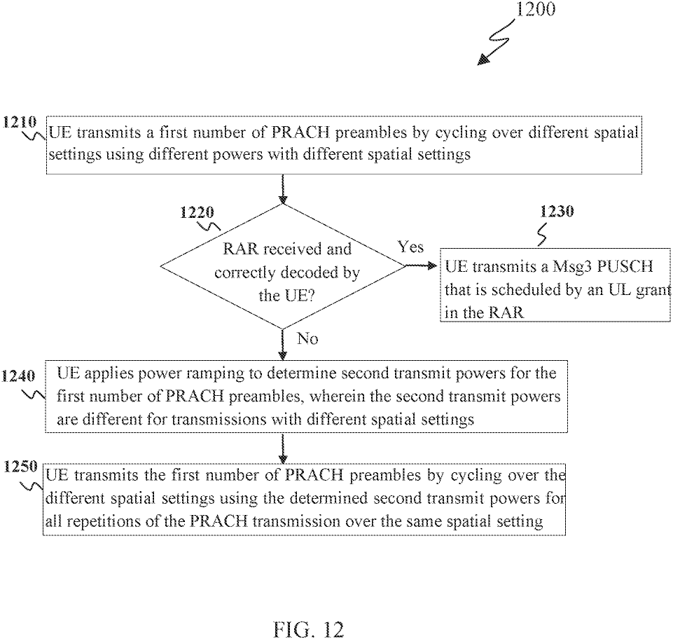

FIG. 12 illustrates an example method 1200 for PRACH transmissions over multiple spatial settings with different powers according to embodiments of the present disclosure. The embodiment of the method 1200 for PRACH transmissions over multiple spatial settings with different powers illustrated in FIG. 12 is for illustration only. FIG. 12 does not limit the scope of this disclosure to any particular implementation of the method for PRACH transmissions over multiple spatial settings with different powers.

As illustrated in FIG. 12, at step 1210, a UE (such as the UE 116) transmits a first number of PRACH preambles by cycling over different spatial settings using different powers using different powers with different spatial settings. A second number of one or more PRACH preambles can be transmitted with each spatial setting from the different spatial settings, wherein the second number can be indicated in a SIB or determined by the UE, for example as a ratio of a total number of repetitions for a PRACH preamble transmission and a number of spatial settings to be used for the PRACH preamble transmission. The second number of PRACH preambles transmitted over each spatial setting are transmitted with a same power. At step 1220, when the UE receives and correctly decodes a RAR, then at step 1230, the UE transmits a Msg3 PUSCH that is scheduled by an UL grant in the RAR. Otherwise, at step 1240, the UE applies power ramping to determine second transmit powers for the first number of PRACH preambles, wherein the second transmit powers are different for transmissions with different spatial settings. At step 1250, the UE transmits the first number of PRACH preambles by cycling over the different spatial settings using the determined second transmit powers for all repetitions of the PRACH transmission over the same spatial setting.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive a synchronization signal and physical broadcast channel (SS/PBCH) block based on a first spatial filter; and
a processor operably coupled to the transceiver, the processor configured to determine a first power for a physical random access channel (PRACH) based on the SS/PBCH block, wherein:
the transceiver is further configured to transmit first more than one PRACHs using respective first more than one spatial filters,
each of the first more than one spatial filters has a narrower beam-width than the first spatial filter, and
a power for each of the first more than one PRACH transmissions is the first power.

2. The UE of claim 1, wherein:
the transceiver is further configured to receive a system information block (SIB),
the SIB includes a field indicating whether transmission of more than one PRACH preambles with more than one spatial filters is enabled, and
the processor is further configured to, based on the indication, enable transmission of more than one PRACH preambles with more than one spatial filters.

3. The UE of claim 1, wherein:
the transceiver is further configured to transmit second more than one PRACHs,
the second more than one PRACHs use respective second more than one spatial filters, and
the second more than one spatial filters include a spatial filter that is not included in the first more than one spatial filters.

4. The UE of claim 1, wherein:
the transceiver is further configured to transmit second more than one PRACHs, and
the second more than one PRACHs use respective second more than one spatial filters that are a subset of the first more than one spatial filters.

5. The UE of claim 1, wherein:
the transceiver is further configured to receive a system information block (SIB), wherein the SIB includes a field indicating a power offset;
the processor is further configured to determine a second power based on the first power and the power offset; and
the transceiver is further configured to transmit second more than one PRACHs, wherein a power for each of the second more than one PRACH transmissions is the second power.

6. The UE of claim 1, wherein the transceiver is further configured to:
receive a random access response (RAR) after the transmission of the first more than one PRACHs, and
transmit a physical uplink shared channel (PUSCH) with a spatial setting from the first more than one spatial settings, wherein the PUSCH transmission is scheduled by information in the RAR.

7. The UE of claim 6, wherein:
the transceiver is further configured to receive a system information block (SIB),
the SIB indicates:
a first set of PRACH preambles associated with transmission of more than one PRACHs and with transmission of one PUSCH, and
a second set of PRACH preambles associated with transmission of more than one PRACHs and with transmission of PUSCHs, and
the transmission of the first more than one PRACHs is by using a preamble from one of the first set of PRACH preambles and the second set of PRACH preambles.

8. A base station (BS) comprising:
a transceiver configured to transmit a synchronization signal and physical broadcast channel (SS/PBCH) block based on a first spatial filter; and
a processor operably coupled to the transceiver, the processor configured to determine a first power for a physical random access channel (PRACH) based on the SS/PBCH block, wherein:
the transceiver is further configured to receive first more than one PRACHs using respective first more than one spatial filters,
each of the first more than one spatial filters has a narrower beam-width than the first spatial filter, and
a power for each of the first more than one PRACH receptions is the first power.

9. The BS of claim 8, wherein:
the transceiver is further configured to transmit a system information block (SIB),
the SIB includes a field indicating whether reception of more than one PRACH preambles with more than one spatial filters is enabled, and
the indication is for enabling reception of more than one PRACH preambles with more than one spatial filters.

10. The BS of claim 8, wherein:
the transceiver is further configured to receive second more than one PRACHs,
the second more than one PRACHs use respective second more than one spatial filters, and
the second more than one spatial filters include a spatial filter that is not included in the first spatial filters.

11. The BS of claim 8, wherein:
the transceiver is further configured to transmit a system information block (SIB), wherein the SIB includes a field indicating a power offset;
the processor is further configured to determine a second power based on the first power and the power offset; and
the transceiver is further configured to receive second more than one PRACHs, wherein a power for each of the second more than one PRACH receptions is the second power.

12. The BS of claim 8, wherein the transceiver is further configured to:
transmit a random access response (RAR) after the reception of the first more than one PRACHs, and
receive a physical uplink shared channel (PUSCH) with a spatial setting from the first more than one spatial settings, wherein the PUSCH reception is scheduled by information in the RAR.

13. The BS of claim 12, wherein:
the transceiver is further configured to transmit a system information block (SIB),
the SIB indicates:
a first set of PRACH preambles associated with reception of more than one PRACHs and with reception of one PUSCH, and
a second set of PRACH preambles associated with reception of more than one PRACHs and with reception of PUSCHs, and
the reception of the first more than one PRACHs is by using a preamble from one of the first set of PRACH preambles and the second set of PRACH preambles.

14. A method comprising:
receiving a synchronization signal and physical broadcast channel (SS/PBCH) block based on a first spatial filter;
determining a first power for a physical random access channel (PRACH) based on the SS/PBCH block; and
transmitting first more than one PRACHs using respective first spatial filters, wherein:
each of the first more than one spatial filters has a narrower beam-width than the first more than one spatial filter; and
a power for each of the first more than one PRACH transmissions is the first power.

15. The method of claim 14, further comprising:
receiving a system information block (SIB), wherein the SIB includes a field indicating whether transmission of more than one PRACH preambles with more than one spatial filters is enabled; and
enabling, based on the indication, transmission of more than one PRACH preambles with more than one spatial filters.

16. The method of claim 14, further comprising transmitting second more than one PRACHs,
wherein the second more than one PRACHs use respective second more than one spatial filters, and
wherein the second more than one spatial filters include a spatial filter that is not included in the first more than one spatial filters.

17. The method of claim 14, further comprising transmitting second more than one PRACHs,
wherein the second more than one PRACHs use respective second more than one spatial filters that are a subset of the first more than one spatial filters.

18. The method of claim 14, further comprising:
receiving a system information block (SIB), wherein the SIB includes a field indicating a power offset;
determining a second power based on the first power and the power offset; and
transmitting second more than one PRACHs, wherein a power for each of the second more than one PRACH transmissions is the second power.

19. The method of claim 14, further comprising:
receiving a random access response (RAR) after the transmission of the first more than one PRACHs; and
transmitting a physical uplink shared channel (PUSCH) with a spatial setting from the first spatial settings, wherein the PUSCH transmission is scheduled by information in the RAR.

20. The method of claim 19, further comprising receiving a system information block (SIB), wherein:
the SIB indicates:
a first set of PRACH preambles associated with transmission of more than one PRACHs and with transmission of one PUSCH, and
a second set of PRACH preambles associated with transmission of more than one PRACHs and with transmission of more than one PUSCHs, and
the transmission of the first more than one PRACHs is by using a preamble from one of the first set of PRACH preambles and the second set of PRACH preambles.
